(19) United States
(12) Patent Application Publication
(10) Pub. No.: US 2009/0106445 A1
(43) Pub. Date: Apr. 23, 2009

(54) METHOD AND APPARATUS FOR MODEL-BASED PAGEVIEW LATENCY MANAGEMENT

(75) Inventors: Yiyu Chen, Zurich (CH); David P. Olshefski, Danbury, CT (US); Li Zhang, Yorktown Heights, NY (US)

Correspondence Address: CANTOR COLBURN LLP-IBM YORKTOWN, 20 Church Street, 22nd Floor, Hartford, CT, 06103, US

(73) Assignee: International Business Machines Corporation, Armonk, NY (US)

(21) Appl. No.: 12/193,202

(22) Filed: Aug. 18, 2008

Related U.S. Application Data
(63) Continuation of application No. 11/876,061, filed on Oct. 22, 2007.

(51) Int. Cl. G06F 15/16

(52) U.S. Cl. 709/233

(57) ABSTRACT

Within exemplary embodiments of the present invention a methodology for response time management for a web page-view download operation is provided. The methodology providing a server-side approach for optimizing weighted, per class, client perceived web page-view download response time. Further, a model for monitoring web page-views download latency in real-time based upon the behavior typically seen from conventional web browsers.

### CROSS-REFERENCE TO RELATED APPLICATIONS

This application is a continuation of U.S. patent application Ser. No. 11/876,061, filed Oct. 22, 2007, the disclosure of which is incorporated by reference herein in its entirety.

### BACKGROUND

1. Field of the Invention

This invention relates to webpage and webpage content delivery, and particularly to the management of webpage page-view latency effects.

2. Description of Background

Generally, a web page-view consists of multiple objects: a container page (such as the HTML object) and the embedded objects that are associated with the container page (e.g. images). In order to manage the response time of the delivery of a web page-view, two key issues must be addressed. First, response time must be managed on a per page-view basis, as perceived by the remote client. Managing server response time per URL request is irrelevant to the remote client that is expecting to download all the objects that compose a complete page-view. Second, the impact that web browser behavior has on both the client perceived page-view response time and the kinds of processing occurring within the server complex must be embodied within a management approach. Existing solutions only manage the server response time on a per URL basis, as opposed to managing the remote client perceived response time on a per page-view basis.

### SUMMARY OF THE INVENTION

The shortcomings of the prior art are overcome and additional advantages are provided through the provision of a method for the management of the response time for the page-view of a webpage download. The method comprises modifying inter-arrival times for a class of page-view objects, wherein for every SYN arrival, if the SYN is a retransmission then the SYN is dropped, if the SYN is the first SYN of a second or subsequent connection then the SYN is accepted, and if the SYN is the first SYN of the first connection then:

if

$${IAT}^{C} \leq \frac{1}{{λ}^{{C}^{*}}} ,$$

then accept the SYN and update IAT^{C}, and

if

$${IAT}^{C} \geq \frac{1}{{λ}^{{C}^{*}}} ,$$

then append IAT^{C} to a buffer,
and for every first connection departure:

if

$${IAT}^{C} \leq \frac{1}{{λ}^{{C}^{*}}} ,$$

then retransmit the youngest first SYN in the buffer, and update IAT^{C},
and for every

$$\frac{1}{{λ}^{{C}^{*}}}$$

seconds, if

$${IAT}^{C} \leq \frac{1}{{λ}^{{C}^{*}}}$$

retransmit youngest first SYN in the buffer and update IAT^{C}.

The method further comprises concurrently modifying communication connections for the class of page-view objects, wherein for each SYN arrival, if the SYN transmission is a retransmission then the SYN is dropped, if the SYN is the first SYN of a second or subsequent connection then the SYN is accepted, further, if the SYN is the first SYN of a first connection:
if FQ^{c}+1≦Q^{C*}, then the SYN is accepted, otherwise the SYN is appended to the buffer and MQ^{C} incremented, and

for every first connection departure, if FQ^{c}≦Q^{C*}, retransmit the youngest first SYN in the buffer and decrement MQ^{C}.

The method yet further comprises controlling the response time for the class of page-view objects, wherein for each SYN arrival:
if the SYN is a SYN retransmission, then drop the SYN,
if the SYN is the first SYN of a second or subsequent connection, then accept the SYN,
if the SYN is the first SYN of the first connection and if λ^{C}RT^{C}≦λ^{C*}RT^{C*}, then accept the SYN and update λ^{C} and RT^{C},

otherwise append the SYN to the buffer and update λ^{C} and RT^{C}, and for every first connection departure, if λ^{C}RT^{C}≦λ^{C*}RT^{C*}, then retransmit the youngest first SYN in the buffer update λ^{C} and RT^{C}.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which optimizes page-view response times across multiple service class environments.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a page-view download latency model.

FIG. 2 illustrates one example of three-tier server model in accordance with exemplary embodiments of the present invention.

The detailed description explains the preferred embodiments of the invention, together with advantages and features, by way of example with reference to the drawings.

### DETAILED DESCRIPTION

One or more exemplary embodiments of the invention are described below in detail. The disclosed embodiments are intended to be illustrative only since numerous modifications and variations therein will be apparent to those of ordinary skill in the art.

Within exemplary embodiments of the present invention a methodology for response time management for a web page-view download operation is provided. The methodology providing a server-side approach for optimizing weighted, per class, client perceived web page-view download response time. Further, a model for monitoring web page-views download latency in real-time based upon the behavior typically seen from conventional web browsers. As such, the service latency model is executed at a three-tier web server complex and based on the service of full page-view downloads (i.e., a HTML document plus its embedded objects).

Further, exemplary embodiments of the present invention comprise three control mechanisms that are capable of enforcing latency management solutions based on a number of per class active connections for a class of objects, the per class arrival rate for a class of objects, and the product of the per class arrival rate and the page-view response time for a class of objects.

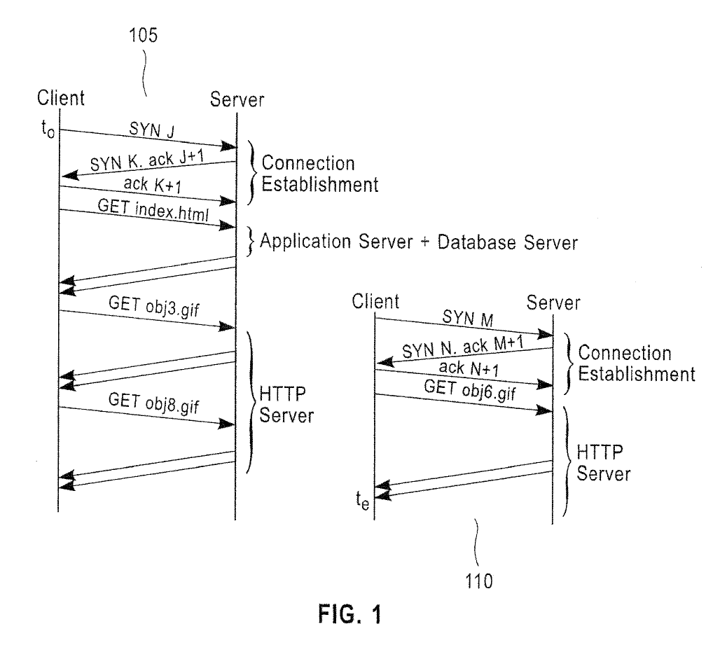

The present exemplary embodiment implements a decomposed web page-view model based on the behavior of existing conventional web browsers and the related activities at the server complex as shown in FIG. 1. As shown, FIG. 1 depicts a set of HTML data delivery activities-in addition to a set of precedence relationships-that are occurring at a primary server and a secondary server (connections 105 and 110). For example, the second connection at the secondary server 110 will not be established until sometime after the HTML document on the first connection 105 has been retrieved and parsed.

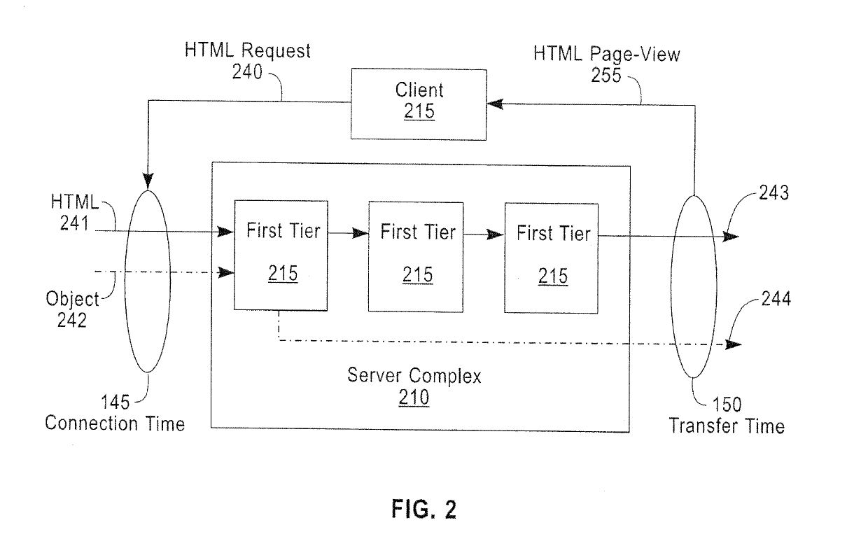

Generally, a web page-view consists of multiple objects: a container page (such as the HTML object) and the embedded objects that are associated with the container page (e.g. images). On a client's side, today's web browsers develop a web page-view for a user by opening multiple connections to a web server complex over which multiple objects are retrieved in parallel. FIG. 2 depicts an exemplary embodiment of the present invention wherein a server complex 210 is implemented to deliver HTML 213 and object data 244 in response to a request 240 that is received from a remote client's 205 web browser. Each system (215, 220, and 225) within the server complex 210 provides processing of a part of an overall web page-view.

A request for a web page 240 is received form the remote client 205 and delivered to the server complex 210. At the server side, the web server complex 210 consists of multiple tiers (215, 220, and 225); each tier consisting of a set of machines and processes that are geared towards servicing a specific type of web object—as is know to those of ordinary skill in the art. For example, the first tier 215 of the server complex 210 (which for example may comprise an Apache HTTP server) may pass requests for dynamic content onto the second tier 220 but service requests for static content by transferring embedded images back to the client. The second tier may consist of application servers that provide dynamical content such as HTML objects (e.g., an Apache Tomcat server). In operation the second tier processes of server 220 may place several queries to a backend database at 225 (e.g. a MySQL database). As such, there exists a direct relationship between how web browsers request web objects and the kinds of processing that occurs within the server complex 210.

Individual latencies for requested HTNL 241 and object 242 data are determined from the connection time 145 and data transfer time 150 for each portion of a page-view which in turn provides the overall latency of a page-view that is perceived by the remote client 205. By modifying page-view content, the load between systems is thereafter shifted in a predictable way. This operation provides for enhanced latency management of a page-view for an end user.

Within the exemplary embodiments of the present invention three control mechanisms are implemented in order to achieve optimal page-view response time across multiple service class environments. The control mechanisms comprise the following control structures (wherein SYN are TCP packets wherein the TCP SYN flag set to 1).

A first control mechanism is an inter-arrival time control mechanism wherein IAT^{c} refers to the estimation of the inter-arrival for a class of web pages-views labeled “C” that are admitted within the operating environment. Further λ^{c} refers to a target mean admission rate for the class C of web page-views so that we arrive at a solution specifying that for every SYN arrival: if the SYN arrival is a SYN that has been retransmitted then the SYN arrival is dropped; if the SYN arrival is the first SYN arrival of a second or subsequent connection then the SYN arrival is accepted; and, if the SYN arrival is the first SYN arrival of the first connection, then if

$${IAT}^{C} \leq \frac{1}{{λ}^{{C}^{*}}} ,$$

the SYN is accepted and IAT^{C} is updated. Otherwise the SYN arrival is appended to the buffer of a packet sniffer analyzer. For every first connection departure, if

$${IAT}^{C} \leq \frac{1}{{λ}^{{C}^{*}}}$$

then the youngest first SYN arrival in the packet sniffing buffer is retransmitted. Further, IAT^{C} is updated and for every

$$\frac{1}{{λ}^{{C}^{*}}}$$

seconds, if

$${IAT}^{C} \leq \frac{1}{{λ}^{{C}^{*}}} ,$$

then the youngest first SYN arrival in the packet sniffing buffer is retransmitted and IAT^{C} is updated.

A secondary control mechanism comprises a concurrent connection control mechanism wherein: FQ^{c} represents the current number of first connection for a class “C” that is currently being serviced; MQ^{c} represents the number of first connections that are waiting to be admitted for the class C; and Q^{c*} represents the optimal steady state number of first connection for class C that should be simultaneously serviced.

Within the concurrent connection control mechanism for every SYN arrival: if the SYN arrival is a SYN retransmission then the SYN arrival is dropped; if the SYN arrival is the first SYN of a second or subsequent connection then the SYN arrival is accepted; and if the SYN arrival is the first SYN of the first connection, then if FQ^{c}+1≦Q^{C*}, the SYN arrival is accepted. Otherwise the SYN arrival is appended to the packet sniffer's buffer and MQ^{C} is incremented. Further, for every first connection departure if FQ^{c}≦Q^{C*}, the youngest first SYN in the packet sniffing buffer is retransmitted and MQ^{C} is decremented.

A third control mechanism in accordance with exemplary embodiments of the present invention comprises a lambda response-time control mechanism wherein: RT^{c} represents the estimate for the mean response time for a class “C” of web page-views; RT^{c*} represents the optimal mean response time for the class C of web page-views; λ^{c} represents the optimal mean acceptance rate for the class C of web page-views; and λ^{c*} represents the estimate of the admission rate for the class C of web page-views. Within the lambda response-time control mechanism for every SYN arrival: if the SYN arrival is a SYN retransmission then the SYN arrival is dropped; if the SYN arrival is the first SYN arrival of a second or subsequent connection then the SYN arrival is accepted; and, if the SYN arrival is the first SYN arrival of the first connection, and if λ^{C}RT^{C}≦λ^{C*}RT^{C*}, the SYN arrival is accepted then λ^{C} and RT^{C} are updated. Otherwise, the SYN arrival is appended to the packet sniffer's buffer and λ^{C} and RT^{C} are updated. Further, for every first connection departure, if λ^{C}RT^{C}≦λ^{C*}RT^{C*}, then the youngest first SYN arrival in the packet sniffer's buffer is retransmitted and λ^{C} and RT^{C} are updated.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the management of the response time for the page-view of a webpage download, the method comprising:
modifying inter-arrival times for a class of page-view objects, wherein for every SYN arrival, if the SYN is a retransmission then the SYN is dropped, if the SYN is the first SYN of a second or subsequent connection then the SYN is accepted, and if the SYN is the first SYN of the first connection then:
if
$${IAT}^{C} \leq \frac{1}{{λ}^{{C}^{*}}} ,$$
if then accept the SYN and update IAT^{C}, and
if
$${IAT}^{C} \geq \frac{1}{{λ}^{{C}^{*}}} ,$$
then append IAT^{C} to a buffer,
and for every first connection departure:
if
$${IAT}^{C} \leq \frac{1}{{λ}^{{C}^{*}}} ,$$
then retransmit the youngest first SYN in the buffer, and update IAT^{C},
and for every
$$\frac{1}{{λ}^{{C}^{*}}}$$
seconds, if
$${IAT}^{C} \leq \frac{1}{{λ}^{{C}^{*}}}$$
retransmit youngest first SYN in the buffer and update IAT^{C};
concurrently modifying communication connections for the class of page-view objects, wherein for each SYN arrival, if the SYN transmission is a retransmission then the SYN is dropped, if the SYN is the first SYN of a second or subsequent connection then the SYN is accepted, further, if the SYN is the first SYN of a first connection:
if FQ^{c}+1≦Q^{C*}, then the SYN is accepted, otherwise the SYN is appended to the buffer and MQ^{C} incremented, and
for every first connection departure, if FQ^{c}≦Q^{C*}, retransmit the youngest first SYN in the buffer and decrement MQ^{C}; and
controlling the response time for the class of page-view objects, wherein for each SYN arrival:
if the SYN is a SYN retransmission, then drop the SYN,
if the SYN is the first SYN of a second or subsequent connection, then accept the SYN,
if the SYN is the first SYN of the first connection and if λ^{C}RT^{C}≦λ^{C*}RT^{C*}, then accept the SYN and update λ^{C} and RT^{C},
otherwise append the SYN to the buffer and update λ^{C} and RT^{C}, and for every first connection departure, if λ^{C}RT^{C}≦λ^{C*}RT^{C*}, then retransmit the youngest first SYN in the buffer update λ^{C} and RT^{C}.
